(19) United States
(12) Patent Application Publication
(10) Pub. No.: US 2019/0369253 A1
(43) Pub. Date: Dec. 5, 2019

(54) Edge Detection Circuit and Detection of Features on Illuminated Eye Using the Same

(71) Applicant: North Inc., Kitchener (CA)

(72) Inventors: Idris S. Aleem, Kitchener (CA); Andrew S. Logan, Waterloo (CA); Nicholas Ford, Kitchener (CA); David Vandervies, Waterloo (CA); Zachary R. MacLennan, Toronto (CA)

(21) Appl. No.: 16/410,018

(22) Filed: May 13, 2019

Related U.S. Application Data
(60) Provisional application No. 62/680,273, filed on Jun. 4, 2018.

(51) Int. Cl. G01S 17/66; G06F 3/01; G01B 11/02

(52) U.S. Cl. CPC G01S 17/66; G01B 11/028; G06F 3/013

(57) ABSTRACT

An edge detection circuit receives a detector signal from an infrared detector positioned and oriented to detect reflections of infrared light from a scan area including at least a portion of an eye, detects an edge of at least one feature of the eye from the detector signal, and outputs information about a position of the edge of the feature relative to the scan area.

### CROSS-REFERENCE TO RELATED APPLICATIONS

This application claims the benefit of U.S. Provisional Application No. 62/680273, filed 4 Jun. 2018, titled “Edge Detection Circuit and Detection of Features on Illuminated Eye Using the Same”, the content of which is incorporated herein in its entirety by reference.

### TECHNICAL FIELD

This disclosure generally relates to eye tracking technologies and particularly relates to eye tracking technologies for wearable heads-up displays.

### BACKGROUND

There is a new generation of wearable heads-up displays that can be worn on the head like conventional eyeglasses. These wearable heads-up displays are electronic devices that, when worn on the head of users, enable the users to see displayed content without preventing the users from seeing the environment. Since these devices display content in a field of view of the user, there naturally flows a desire to enable the eye as an interface or portal through which the user and device can interact with each other. The ability to track the eye gaze of the user relative to a display space in the field of view of the user in real time would enable such an interface.

Eye tracking is a process by which one or more of position, orientation, and motion of an eye may be measured or monitored. There are various techniques for measuring the position, orientation, and/or motion of the eye, the least invasive of which employs one or more optical sensors, e.g., cameras, to optically track the eye. Common techniques involve illuminating or flooding the eye with infrared light and measuring reflections from the eye with at least one optical sensor that is tuned to be sensitive to the infrared light. Information about how the infrared light is reflected from the eye is analyzed to determine the position, orientation, and/or motion of one or more eye features such as the cornea, pupil, iris, and/or retinal blood vessels.

Glint position and glint-pupil vector are two parameters that can be determined from reflections of infrared light from an eye. Glint appears as a bright spot on the cornea of the eye when the eye is illuminated with infrared light, and glint-pupil vector is a vector formed by joining the centers of the glint and pupil. Some wearable heads-up displays have the ability to scan infrared light over the eye and detect reflections of infrared light from the eye. To enable an eye-machine interface that is based on eye tracking by glint and/or glint-pupil vector, these wearable heads-up displays would need to be able to detect glint and pupil in real time.

### SUMMARY

An edge detection circuit that in use is communicatively coupled to an infrared detector that is positioned and oriented to detect reflections of infrared light from an eye may be summarized as including an edge comparator circuitry, a time-counter circuitry communicatively coupled to the edge comparator circuitry, and a processor module communicatively coupled to the edge comparator circuitry and the timer-counter circuitry. The edge comparator circuitry includes a comparator having a first input node to receive an infrared detector output signal from the infrared detector, a second input node to receive a feature threshold signal of a select feature of the eye, and an output node to output a comparator output signal representative of a comparison between the infrared detector output signal and the feature threshold signal, where the select feature of the eye includes at least one of a pupil of the eye and a glint on the eye. The timer-counter circuitry includes a counter that is responsive to a source of successive clock signals. The timer-counter circuitry further includes a capture register that is communicatively coupled to the output node of the comparator to detect rising and falling edges of the comparator output signal. The capture register is also communicatively coupled to an output node of the counter to latch a value of the counter when a rising edge or a falling edge of the comparator output signal is detected. The processor module includes a processor that is communicatively coupled to the second input node of the comparator to provide the feature threshold signal to the second input node of the comparator. The processor is also communicatively coupled to the capture register to receive an interrupt signal from the capture register and to retrieve the counter value latched in the capture register in response to the interrupt signal received from the capture register.

The select feature of the eye is a pupil of the eye. The edge comparator circuitry further includes a path through which the infrared detector output signal is received at the first node of the comparator, wherein the path includes an amplifier to boost a power of the infrared detector output signal. The path through which the infrared detector output signal is received at the first node of the comparator further includes a clamping circuit to clamp the infrared detector output signal received at an input of the amplifier to a defined voltage range. The edge comparator circuitry further includes a path through which the infrared detector output signal is provided to the processor module, wherein the path includes an analog-to-digital converter.

The edge comparator circuitry further includes a path through which the feature threshold signal is received at the second node of the comparator, wherein the path includes a digital-to-analog converter.

The timer-counter circuitry further includes a first sync register communicatively coupled to receive a first timing sync signal, the first sync register communicatively coupled to the counter and operable to latch the value of the counter in response to receiving the first timing sync signal. The timer-counter circuitry further includes a second sync register communicatively coupled to receive a second timing sync signal, the second sync register communicatively coupled to the counter and operable to latch the value of the counter in response to receiving the second timing sync signal. The processor is communicatively coupled to each of the first sync register and the second sync register to receive the counter value latched in each of the first sync register and the second sync register in response to the interrupt signal from the capture register. The processor module further includes a clock, wherein the capture register, the counter, the first sync register, and the second sync register are communicatively coupled to the clock to receive clock signals. The processor module further includes a non-transitory processor-readable storage medium that is communicatively coupled to the processor, wherein the non-transitory processor-readable storage medium stores data and/or processor-executable instructions that, when executed by the processor, cause the processor to determine a coordinate of a point on an edge of the select feature of the eye based on the counter values retrieved from the capture register, the first sync register, and the second sync register.

The edge detection circuit further includes a signal conditioning circuitry communicatively coupled to the edge comparator circuitry, the signal conditioning circuitry including a transimpedance amplifier that converts the infrared detector output signal from a current signal to a voltage signal. The signal conditioning circuitry further includes a filter to reject ambient light from the infrared detector output signal. The signal conditioning circuitry further includes a bandpass filter to pass a select frequency range of the infrared detector output signal.

The select feature of the eye is a pupil of the eye. The processor is communicatively coupled to the edge comparator circuitry receive samples of the infrared detector output signal from the edge comparator circuitry. The processor module further includes a non-transitory processor-readable storage medium that is communicatively coupled to the processor, wherein the non-transitory processor-readable storage medium stores data and/or processor-executable instructions that, when executed by the processor, cause the processor to: detect a portion of the samples of the infrared detector output signal attributable to an iris region of the eye; determine an average signal intensity of the portion of the samples of the infrared detector output signal attributable to an iris region of the eye; and determine the feature threshold signal based on the average signal intensity.

The select feature of the eye is a pupil of the eye. The processor is communicatively coupled to the edge comparator circuitry to receive samples of the infrared detector output signal from the edge comparator circuitry. The processor module further includes a non-transitory processor-readable storage medium that is communicatively coupled to the processor, wherein the non-transitory processor-readable storage medium stores data and/or processor-executable instructions that, when executed by the processor, cause the processor to: detect a portion of the samples of the infrared detector output signal attributable to a region of the eye outside of a glint on the eye; determine a maximum signal intensity of the portion of the samples of the infrared detector output signal attributable to a region of the eye outside of the glint on the eye; and determine the feature threshold signal based on the maximum signal intensity.

The timer-counter circuitry and processor module are implemented in a microcontroller.

An edge detection circuit to detect one or more features of an eye may be summarized as including a pupil edge comparator circuitry that in use is communicatively coupled to an infrared detector that is positioned and oriented to detect reflections of infrared light from an eye, a glint edge comparator circuitry that in use is communicatively coupled to the infrared detector that is positioned and oriented to detect reflections of infrared light from the eye, a timer-counter circuitry that is communicatively coupled to the pupil edge comparator circuitry and the glint edge comparator circuitry, and a processor module that is communicatively coupled to the pupil edge comparator circuitry and the timer-counter circuitry. The pupil edge comparator circuitry includes a pupil comparator having a first input node to receive an infrared detector output signal from the infrared detector, a second input node to receive a pupil threshold signal, and an output node to output a pupil comparator output signal representative of a comparison between the infrared detector output signal and the pupil threshold signal. The glint edge comparator circuitry includes a glint comparator having a first input node to receive the infrared detector output signal from the infrared detector, a second input node to receive a glint threshold signal, and an output node to output a glint comparator output signal representative of a comparison between the infrared detector output signal and the glint threshold signal. The timer-counter circuitry includes a counter that is responsive to a source of successive clock signals, a pupil register that is communicatively coupled to the output node of the pupil comparator to detect rising and falling edges of the pupil comparator output signal and to an output node of the counter to latch a value of the counter when a rising edge or a falling edge of the pupil comparator output signal is detected, and a glint register that is communicatively coupled to the output node of the glint comparator to detect rising and falling edges of the glint comparator output signal and to an output node of the counter to latch a value of the counter when a rising edge or a falling edge of the glint comparator output signal is detected. The processor module includes a processor communicatively coupled to the second input node of the pupil comparator to provide the pupil threshold signal to the second input node of the pupil comparator. The processor is communicatively coupled to the pupil register to receive an interrupt signal from the pupil register and to retrieve the counter value latched in the pupil register in response to the interrupt signal received from the pupil register. The processor is also communicatively coupled to the glint register to receive an interrupt signal from the glint register and to retrieve the counter value latched in the glint register in response to the interrupt signal received from the glint register.

The processor is communicatively coupled to the second input node of the glint comparator to provide the glint threshold signal to the second input node of the glint comparator. The glint edge comparator circuitry further includes a path through which the glint threshold signal is received at the second input node of the glint comparator, wherein the path includes a digital-to-analog converter.

The pupil edge comparator circuitry further includes a path through which the infrared detector output signal is received at the first node of the pupil comparator, wherein the path includes an amplifier to boost a power of the infrared detector output signal. The path through which the infrared detector output signal is received at the first node of the pupil comparator further includes a clamping circuit to clamp the infrared detector output signal received at an input of the amplifier to a select voltage range.

The pupil edge comparator circuitry further comprises a path through which the infrared detector output signal is provided to the processor module, wherein the path includes an analog-to-digital converter.

The pupil edge comparator circuitry further includes a path through which the pupil threshold signal is received at the second node of the pupil comparator, wherein the path includes a digital-to-analog converter.

The timer-counter circuitry further includes a first sync register that in use is communicatively coupled to an optical scanner driver to receive a first timing sync signal from the optical scanner driver, and the first sync register is communicatively coupled to the counter and operable to latch the value of the counter in response to receiving the first timing sync signal. The processor is communicatively coupled to each of the first sync register and the second sync register to receive the counter value latched in each of the first sync register and the second sync register in response to the interrupt signal from the pupil register and the interrupt signal from the glint register. The processor module includes a clock, and the pupil register, the glint register, the counter, the first sync register, and the second sync register are communicatively coupled to the clock to receive clock signals. The processor module further includes a memory that is communicatively coupled to the processor, wherein the memory stores data and/or processor-executable instructions that, when executed by the processor, causes the processor to determine a coordinate of a point on an edge of a pupil of the eye based on the counter values retrieved from the pupil register, the first sync register, and the second sync register.

The edge detection circuit further includes a signal conditioning circuitry communicatively coupled to the pupil edge comparator circuitry and the glint edge comparator circuitry, and the signal conditioning circuitry includes a transimpedance amplifier that converts the infrared detector output signal from a current signal to a voltage signal. The signal conditioning circuitry further includes a filter to reject ambient light from the infrared detector output signal. The signal conditioning circuitry further includes a bandpass filter to pass a select frequency range of the infrared detector output signal.

The processor is communicatively coupled to the pupil edge comparator circuitry to receive samples of the infrared detector output signal from the pupil edge comparator circuitry, and the processor module further includes a non-transitory processor-readable storage medium that is communicatively coupled to the processor, wherein the non-transitory processor-readable storage medium stores data and/or processor-executable instructions that, when executed by the processor, cause the processor to: detect a portion of the samples of the infrared detector output signal attributable to an iris region of the eye; determine an average signal intensity of the portion of the samples of the infrared detector output signal attributable to the iris region of the eye; and determine the pupil threshold signal based on the average signal intensity.

The processor is communicatively coupled to the pupil edge comparator circuitry to receive samples of the infrared detector output signal from the pupil edge comparator circuitry, and the processor module further includes a non-transitory processor-readable storage medium that is communicatively coupled to the processor, wherein the non-transitory processor-readable storage medium stores data and/or processor-executable instructions that, when executed by the processor, cause the processor to: detect a portion of the samples of the infrared detector output signal attributable to a region of the eye outside of a glint on the eye; determine a maximum signal intensity of the portion of the samples of the infrared detector output signal attributable to the region of the eye outside of the glint on the eye; and determine the pupil threshold signal based on the maximum signal intensity.

A method of detecting one or more features of an eye may be summarized as including generating an infrared light; sweeping the infrared light across the eye; detecting, by an infrared detector, reflections of the infrared light from the eye; receiving at a first input node of a comparator an infrared detector output signal from the infrared detector; receiving a feature threshold signal of a select feature of the eye from a processor at a second input node of the comparator; comparing the infrared detector output signal to the feature threshold signal in the comparator and outputting a comparator output signal from the comparator that is representative of the comparison between the infrared detector output signal and the feature threshold signal; detecting, by a register, rising and falling edges of the comparator output signal; capturing in the register a time of arrival of at least one of the rising and falling edges of the comparator output signal; and determining a coordinate of at least one point on an edge of the select feature based on the time of arrival captured in the register.

The select feature is selected from a pupil of the eye and a glint on the eye.

The select feature is a pupil of the eye, and the method further includes adjusting the feature threshold signal based on changes in the infrared detector output signal.

Adjusting the feature threshold signal includes receiving samples of the infrared detector output signal for a current sweep of the eye with infrared light, detecting a portion of the samples attributable to an iris region of the eye, determining an average signal intensity from the portion of the samples attributable to the iris region of the eye, and determining the feature threshold signal for a next sweep of the eye based on the average signal intensity.

Adjusting the feature threshold signal includes detecting a glint on the eye during a current sweep of the eye with infrared light, receiving samples of the infrared detector output signal from the current sweep of the eye with infrared light, detecting a portion of the samples attributable to a region of the eye outside of the glint on the eye, determining a maximum signal intensity from the portion of the samples attributable to the region of the eye outside of the glint on the eye, and determining the feature threshold signal for at least one of the current sweep of the eye and the next sweep of the eye based on the maximum signal intensity.

A system to detect one or more features of an eye may be summarized as including a laser module to generate infrared light, the laser module having at least one infrared laser diode; an optical scanner to sweep the infrared light over the eye, the optical scanner having at least one scan mirror; an infrared detector positioned and oriented to detect reflections of the infrared light from the eye during each sweep of the infrared light over the eye; a comparator having a first input node to receive an infrared detector output signal from the infrared detector, a second input node to receive a feature threshold signal of a select feature of the eye, and an output node to output a comparator output signal representative of a comparison between the infrared detector output signal and the feature threshold signal, the select feature of the eye including at least one of a pupil of the eye and a glint on the eye; a counter that is responsive to a source of successive clock signals; a capture register that is communicatively coupled to the output node of the comparator to detect rising and falling edges of the comparator output signal and to an output node of the counter to latch a value of the counter when a rising edge or a falling edge of the comparator is detected; a processor communicatively coupled to the second input node of the comparator to provide the feature threshold signal to the second input node of the comparator, the processor communicatively coupled to the capture register to receive an interrupt signal from the capture register and to retrieve the counter value latched in the capture register in response to the interrupt signal received from the capture register; and a non-transitory processor-readable storage medium that is communicatively coupled to the processor, wherein the memory stores data and/or processor-executable instructions that, when executed by the processor, causes the processor to determine a coordinate of a point on an edge of the select feature of the eye based on the counter value received from the register.

The foregoing general description and the following detailed description are exemplary of the invention and are intended to provide an overview or framework for understanding the nature of the invention as it is claimed. The accompanying drawings are included to provide further understanding of various implementations and embodiments of the invention and are incorporated in and constitute part of this specification. The drawings illustrate various implementations and embodiments of the invention and together with the description serve to explain the principles and operation of the invention.

### BRIEF DESCRIPTION OF DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1A is a schematic diagram of an edge detection circuit, according to at least one illustrated implementation.

FIG. 1B is a schematic diagram of a pupil edge detection arm of the edge detection circuit of FIG. 1A.

FIG. 1C is a schematic diagram of a glint edge detection arm of the edge detection arm of FIG. 1A.

FIG. 2A is a schematic diagram illustrating horizontal scanning of an eye, according to at least one illustrated implementation.

FIG. 2B is a schematic diagram illustrating vertical scanning of an eye, according to at least one illustrated implementation.

FIG. 3 is a schematic diagram illustrating an intersection of pupil edge by a scan line, according to at least one illustrated implementation.

FIG. 4 is a flowchart illustrating a method of adjusting pupil threshold, according to at least one illustrated implementation.

FIG. 5 is a schematic diagram illustrating detection of samples of a detector signal from an iris of an eye, according to at least one illustrated implementation.

FIG. 6 is a schematic diagram showing intersection of a glint edge by a scan line, according to at least one illustrated implementation.

FIG. 7 is a flowchart illustrating a method of adjusting pupil threshold, according to another implementation.

FIG. 8 is a schematic diagram showing components of an exemplary wearable heads-up display, according to at least one illustrated implementation.

### DETAILED DESCRIPTION

In the following description, certain specific details are set forth in order to provide a thorough understanding of various disclosed implementations and embodiments. However, one skilled in the relevant art will recognize that implementations and embodiments may be practiced without one or more of these specific details, or with other methods, components, materials, etc. In other instances, well-known structures associated with portable electronic devices and head-worn devices have not been shown or described in detail to avoid unnecessarily obscuring descriptions of the implementations and the embodiments. For the sake of continuity, and in the interest of conciseness, same or similar reference characters may be used for same or similar objects in multiple figures. For the sake of brevity, the term “corresponding to” may be used to describe correspondence between features of different figures. When a feature in a first figure is described as corresponding to a feature in a second figure, the feature in the first figure is deemed to have the characteristics of the feature in the second figure, and vice versa, unless stated otherwise.

In this disclosure, unless the context requires otherwise, the word “comprise” and variations thereof, such as, “comprises” and “comprising” are to be construed in an open, inclusive sense, that is as “including, but not limited to.”

In this disclosure, reference to “one implementation” or “an implementation” or “one embodiment” or “an embodiment” means that a particular feature, structures, or characteristics may be combined in any suitable manner in one or more implementations or embodiments.

In this disclosure, the singular forms “a,” “an,” and “the” include plural referents unless the content clearly dictates otherwise. It should also be noted that the term “or” is generally employed in its broadest sense, that is, as meaning “and/or” unless the content clearly dictates otherwise.

The headings and Abstract of the disclosure provided herein are for convenience only and do not interpret the scope or meaning of the implementations or the embodiments.

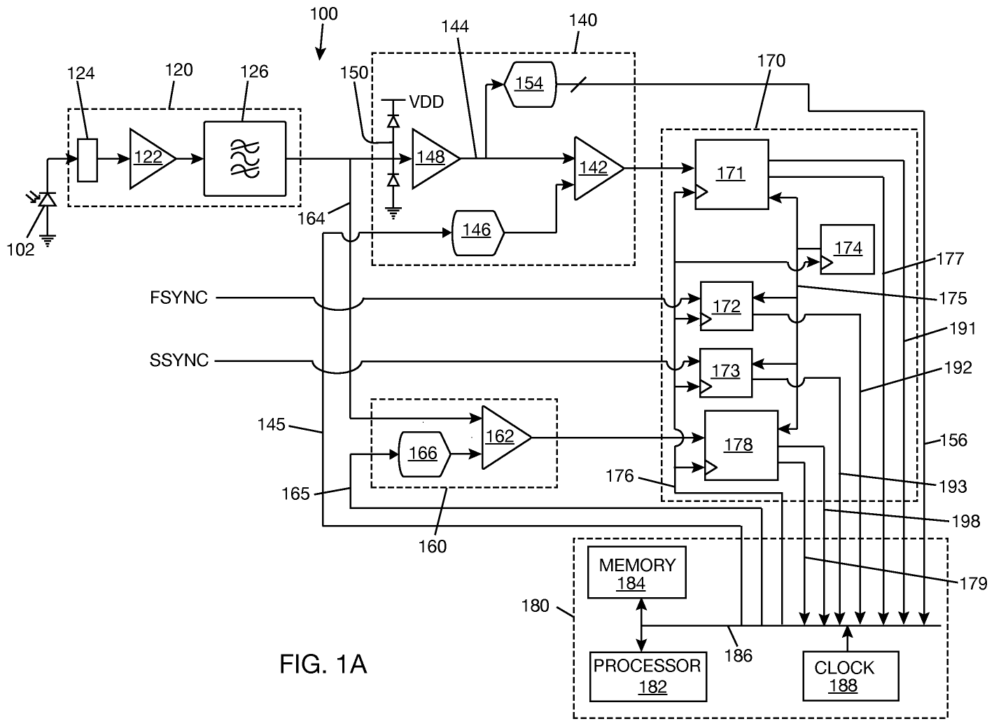

FIG. 1A is a schematic diagram illustrating an edge detection circuit 100 that detects one or more features of an eye from an output signal (“detector signal”) of an infrared detector 102 that is positioned and oriented to detect reflections of infrared light from the eye. In the illustrated implementation, the one or more features are selected from pupil of the eye and glint(s) on the eye. The detector signal provides a measure of intensity of reflections of infrared light detected by infrared detector 102. In one implementation, edge detection circuit 100 includes signal conditioning circuitry 120, pupil edge comparator circuitry 140, glint edge comparator circuitry 160, timer-counter circuitry 170, and processor module 180. In one example, timer-counter circuitry 170 and processor module 180 are implemented in a microcontroller. In another example, edge detection circuit 100 may be implemented as a system on chip or may be integrated with an existing system on chip. In the illustrated implementation, edge detection circuit 100 may be considered as two devices in one (or a device that can be operated in two modes), i.e., a first device (or first mode) that detects pupils from the output of infrared detector 102 and a second device (or second mode) that detects glints from the output of infrared detector 102. It is possible to abstract the pupil edge detection mode from the edge detection circuit 100, as illustrated at 100a in FIG. 1B (in FIG. 1B, timer-counter circuitry 170a includes only the parts related to pupil edge detection). Similarly, it is possible to abstract the glint edge detection mode from the edge detection circuit 100, as illustrated in FIG. 1C (in FIG. 1C, timer-counter circuitry 170b includes only the parts related to glint edge detection).

Returning to FIG. 1A, in one implementation, the detector signal is in the form of a current signal, and signal conditioning circuitry 120 includes a transimpedance amplifier 122, or other current-to-voltage converter, to convert the detector signal to a voltage signal. Signal conditioning circuitry 120 may include a filter 124 to reject ambient light from the detector signal. Filter 124 may be, for example, a resistor-capacitor (RC) filter or an inductor-capacitor (LC) filter, an active DC offset correction with an integrator, or a narrowband infrared (IR) filter. Filter 124 may reject ambient light from the detector signal before the detector signal is passed through transimpedance amplifier 122. Signal conditioning circuitry 120 may include a bandpass filter 126 to pass frequencies of the detector signal within a select range. The bandpass filter 126 may also limit noise power between amplifier stages. The frequency range of the bandpass filter 126 may be based on the operating frequencies of the transimpedance amplifier 122 and other frequency-based devices operating near the edge detection circuit 100, such as an optical scanner that is used to sweep infrared light over the eye. In one non-limiting example, the frequencies passed by bandpass filter 126 may be in a range from 15 kHz to 15 MHz. In another non-limiting example, the frequencies passed by bandpass filter 126 may be in a range from 50 kHz to 15 MHz. The detector signal processed by signal conditioning circuitry 120 is fed to pupil edge comparator circuitry 140, as shown by path 144, and to glint edge comparator circuitry 160, as shown by path 164.

Referring to FIGS. 1A and 1B, in one implementation, pupil edge comparator circuitry 140 includes a pupil comparator 142 (e.g., operational amplifier) that takes the detector signal from signal conditioning circuitry 120 at a first input and a pupil threshold signal as a second input. The pupil threshold signal indicates the intensity that must not be exceeded by the detector signal to consider the detector signal as coming from a pupil of the eye. Pupil comparator 142 may receive the detector signal through path 144 coupling conditioning circuitry 120 to a first input node of pupil comparator 142. In one example, path 144 includes an amplifier 148 to increase the power of the detector signal received from signal conditioning circuitry 120. Amplifier 148 may boost the power of the detector signal by up to 100 times, for example. Path 144 may include a clamping circuit 150 at an input side of amplifier 148 to prevent saturation of amplifier 148. An example clamping circuit 150 may include two diodes, with one diode connected to ground and the other diode connected to a positive voltage VDD. The clamping circuit 150 will clamp the voltage that amplifier 148 receives to between ground voltage and VDD. Other types of clamping circuits besides the example clamping circuit 150 shown in FIGS. 1A and 1B may be used for clamping the voltages applied to amplifier 148. In one implementation, pupil comparator 142 receives the pupil threshold signal from processor module 180, as indicated by path 145 coupling processor module 180 to a second input node of pupil comparator 142. In one example, path 145 includes a digital-to-analog converter (DAC) 146 to convert the digital signal from the processor module 180 to an analog signal that is received by the pupil comparator 142.

In one implementation, processor module 180 includes a processor 182 (i.e., hardware circuity), memory 184 that is communicatively coupled to processor 182, and a clock or timer 188 to synchronize all the parts of processor module 180 and timer-counter circuitry 170 (170a in FIG. 1B, 170b in FIG. 1C). Processor 182 may be a general-purpose processor that performs computational operations. For example, processor 182 can be a central processing unit (CPU) such as a microprocessor, a controller, an application specific integrated circuit (ASIC), or a field-programmable gate array. Memory 184 is a non-transitory computer-readable storage device or medium that stores data and instructions for processor 182. Memory 184 may include one or more of random-access memory (RAM), read-only memory (ROM), Flash memory, solid state drive, or other computer-readable storage device. Processor module 180 also includes peripherals interface, generally indicated as 186, for interaction with the other parts of the edge detection circuit 100. As indicated earlier, processor module 180 and timer-counter circuitry 170 (170a in FIG. 1B, 170b in FIG. 1C) may be implemented in a microcontroller. In one example, processor 182 dynamically computes pupil threshold and provides the pupil threshold signal to pupil comparator 142, as indicated by path 145.

Pupil comparator 142 compares the detector signal to the pupil threshold signal and generates a digital signal that is representative of the comparison. As an example, if the voltage of the detector signal is greater than the voltage of the pupil threshold signal, the pupil comparator 142 generates a digital signal having a first logical value. If the voltage of the detector signal is not greater than the voltage of the pupil threshold signal, the pupil comparator 142 generates a digital signal having a second logical value that is different from the first logical value. For example, the first logical value could be 1 and the second logical value could be 0. However, other logical values may be used. Timer-counter circuitry 170 (170a in FIG. 1B) detects falling and rising edges from the output of the pupil comparator 142. Edges occur when the logical value of the digital signal coming out of pupil comparator 142 changes. For example, a falling edge may be detected when the output of the pupil comparator 142 changes from 1 to 0 (or from the first logical value to the second logical value), and a rising edge may be detected when the output of the pupil comparator 142 changes from 0 to 1 (or from the second logical value to the first logical value). Each falling or rising edge corresponds to a point on the pupil edge.

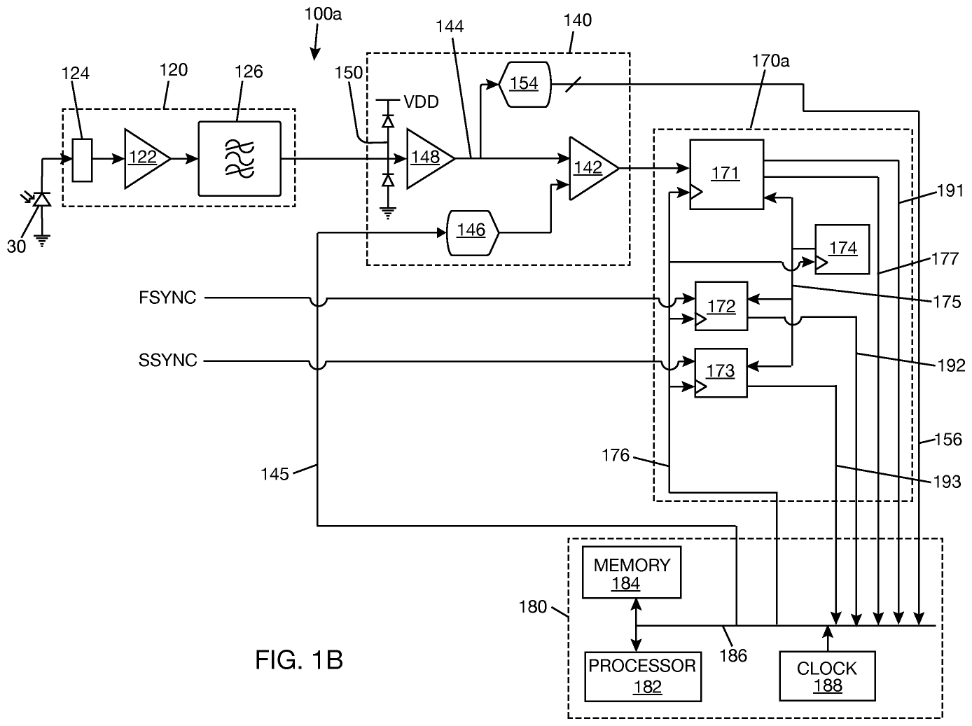

To understand how falling and rising edges correspond to points on the pupil edge, it is helpful to consider sweeping or scanning of an eye with infrared light. For illustration purposes, FIG. 2A shows eye 104 being scanned with infrared light. Assuming that box ABCD represents the scan area, then scanning of the eye with infrared light involves moving a laser beam spot across the scan area ABCD. (It should be noted that the size or position of scan area ABCD is not limited to what is shown in FIG. 2A. For example, scan area ABCD may be made just big enough to contain an area of interest on the eye, i.e., a portion of the eye.) The laser beam spot moves back and forth between lines AB and CD at a relatively fast speed. While moving back and forth between lines AB and CD, the laser beam spot also moves in the X direction at a relatively slow speed. Thus, each scan line, indicated as 200, is sloped or diagonal to an image frame. In one example, each new sweep of the eye starts at A, each scan line running from line AB to CD is sloped towards line CD, and each scan line running from CD to AB is sloped towards line AB. FIG. 2A illustrates vertical scanning of the eye. However, horizontal scanning of the eye may be used instead of vertical scanning. In horizontal scanning, as illustrated in FIG. 2B, the laser beam spot will move back and forth between lines AC and BD at a relatively fast speed and in the Y direction at a relatively slow speed.

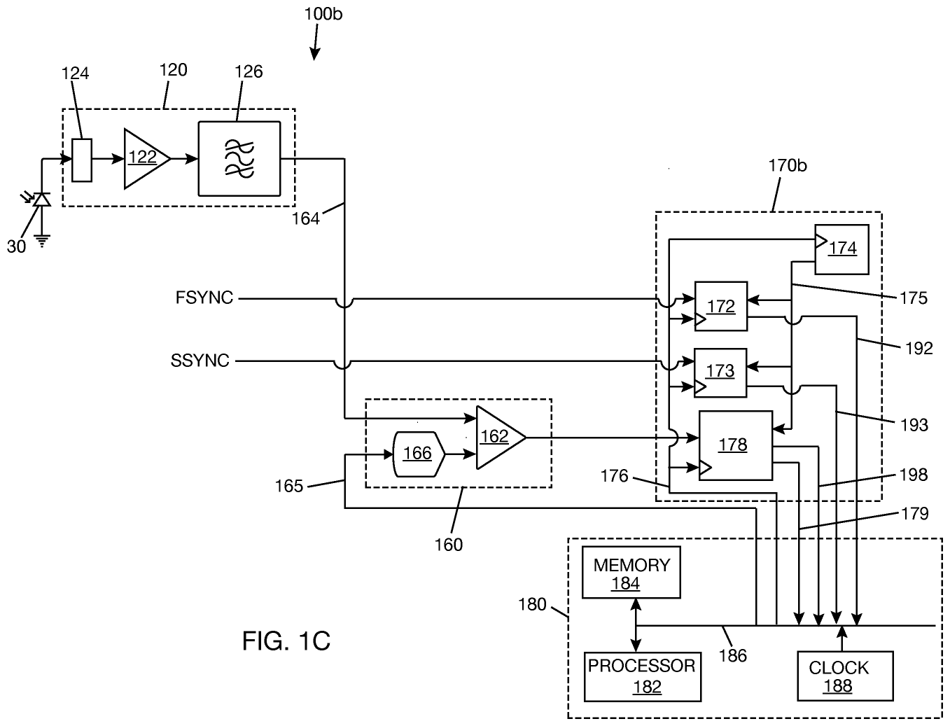

FIG. 3 shows a scan line 202 intersecting the edge of pupil 106 of eye 104 at (xₚ₁, yₚ₁) and (xₚ₂, yₚ₂). Scan line 202 represents any arbitrary scan line that may intersect the edge of pupil 106. Line 300 represents a signal that may be generated for scan line 202 by pupil comparator 142 (in FIGS. 1A and 1B). Assuming that the scan direction of scan line 202 is from line AB to line CD, then line portion 302 represents the falling edge of signal 300, and line portion 304 represents the rising edge of the signal. For each sweep of the eye with infrared light, timer-counter circuitry 170 (170a in FIG. 1B) monitors the output of the pupil comparator 142 for falling and rising edges. For the example shown in FIG. 3, the falling edge 302 of signal 300 will be observed at time tₚ₁, and the rising edge 304 of signal 300 will be observed at time tₚ₂. Time tₚ₁ represents the time that the laser beam spot is at yₚ₁ relative to the beginning of the scan line 202 on line AB. Time tₚ₂ represents the time that the laser beam spot is at yₚ₂ relative to the beginning of scan line 202 on line AB. A third time tₚ₃ can be introduced. Time tₚ₃ represents the time that the current scan line 202 began relative to the time that the current sweep of the eye began. From time tₚ₁, the position yₚ₁ can be inferred. From time tₚ₂, the position yₚ₂ can be inferred. From time tₚ₃, and with knowledge of the slope of scan line 202, the positions xₚ₁ and xₚ₂ can be inferred.

Returning to FIGS. 1A and 1B, in one implementation, timer-counter circuitry 170 (170a in FIG. 1B) includes a capture register 171 that is coupled to an output of pupil comparator 142, a sync register 172 that is coupled to receive a fast-axis timing signal FSYNC from an optical scanner driver, e.g., a scan mirror driver (not shown), a sync register 173 that is coupled to receive a slow-axis timing signal SSYNC from the optical scanner driver (or scan mirror driver), and a counter 174. Registers 171, 172, 173 and counter 174 may be implemented using register-type circuit such as the flip-flop. Registers 171, 172, 173 are coupled to receive counter values from counter 174, as indicated by line 175. Registers 171, 172, 173 and counter 174 are synchronized to clock 188, as indicated by line 176. Each clock cycle, capture register 171 detects the output signal of the pupil comparator 142. When the value of the output signal of the pupil comparator 142 changes from a first logical level to a second logical level or from a second logical level to a first logical level, which corresponds to detection of a pupil edge, capture register 171 latches the value of counter 174 and generates an interrupt signal that is received by processor 182, as indicated by line 177. When register 172 receives fast-axis timing signal FSYNC, sync register 172 latches the value of counter 174. When register 173 receives slow-axis timing signal SSYNC, sync register 173 latches the value of counter 174.

Upon receiving an interrupt signal from register 171, processor 182 retrieves the latched values in registers 171, 172, and 173, as indicated by lines 191, 192, and 193, respectively. Processor 182 computes time tₚ₁ (or tₚ₂), as previously explained with respect to FIG. 3, from the difference between the latched value retrieved from the capture register 171 and the latched value retrieved from the sync register 172. Processor 182 computes time tₚ₃, as previously explained, from the difference between the latched value retrieved from the capture register 171 and the latched value retrieved from sync register 173. Thus, for each point on a pupil edge detected by capture register 171, processor 182 computes time coordinate (tₚ₁, tₚ₃) or (tₚ₂, tₚ₃) for the point. Processor 182 may further compute display coordinate (xₚ₁, yₚ₁) corresponding to time coordinate (tₚ₁, tₚ₃) and display coordinate (xₚ₂, yₚ₂) corresponding to time coordinate (tₚ₂, tₚ₃). A relationship may be determined a priori between time coordinates and display coordinates using affine transformation and the like, and processor 182 may use the relationship to determine display coordinates from time coordinates. Processor 182 may store the time and/or display coordinates determined for the points on the pupil edge in memory 184 and/or output the time and/or display coordinates from the processor module 180.

A gaze point calculator (not shown) may receive the time and/or display coordinates from processor module 180 and use the time and/or display coordinates to compute a pupil center position. In another implementation, processor 182 may further compute a pupil center position from the time and/or display coordinates of points on the pupil edge and output the pupil center position to the gaze point calculator or other device or process that requires the information. In one example, for each sweep of the eye, processor 182 collects enough points on an edge of the pupil to which an ellipse, or other near-circular shape, may be fitted. Processor 182 may fit the ellipse, or other near-circular shape, to the points and then determine the geometric center of the ellipse, or other near-circular shape, as the pupil center position. In another example, if there are not sufficient points on the pupil edge to fit an ellipse, or other near circular shape, a weighted average of the coordinates of the points, or a weighted centroid of a shape formed by the points, may be taken and used as the coordinate of the pupil center position. The weighted centroid approach may also be used even if there are sufficient points to which an ellipse, or other near circular shape, may be fitted.

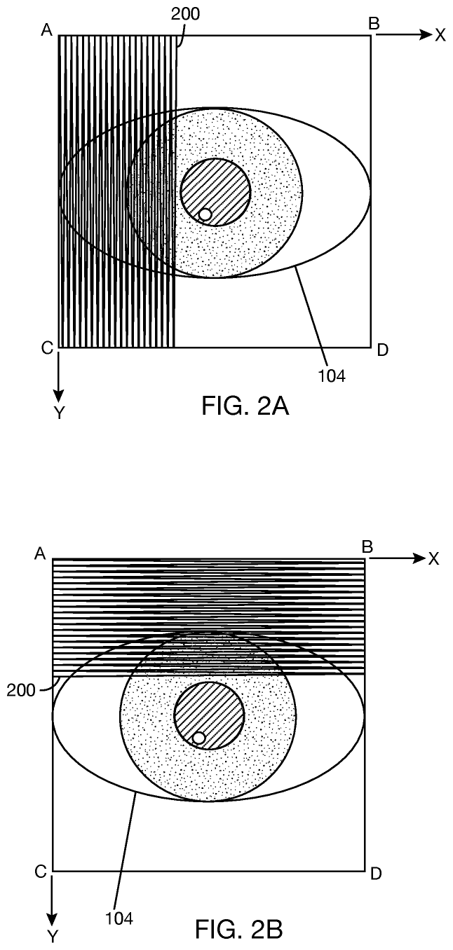

In one implementation, processor 182 determines the pupil threshold that is received at the second input node of pupil comparator 142. Processor 182 may start with a best estimate of the pupil threshold and then adjust the pupil threshold based on changing eye illumination conditions. FIG. 4 is a flowchart illustrating a process for dynamically adjusting the pupil threshold. The process logic may be stored in memory 184 (in FIGS. 1A and 1B) and executed by the processor 182 (in FIGS. 1A and 1B). In one example, at 250, the processor receives samples of the detector signal from a current sweep of the eye with infrared light. As shown in FIGS. 1A and 1B, the detector signal may be sampled through a path 156 formed between pupil detection circuitry 140 and processor module 180. Path 156 may be communicatively coupled to path 144 such that the processor 182 receives substantially the same detector signal that is fed into the pupil comparator 142. Path 156 may include an analog-to-digital converter (ADC) 154 to convert the detector signal to a digital signal that can be processed by processor 182.

Returning to FIG. 4, at 252, processor 182 detects the portion of the samples that is attributable to the iris region of the eye, i.e., the samples generated by reflections from the iris region of the eye. At 254, processor 182 determines an average signal intensity in an area of the iris based on the portion of the samples that is attributable to the iris region of the eye. At 256, processor 182 determines the pupil threshold for the next sweep of the eye based on the average signal intensity determined at 254. In one example, processor 182 sets the pupil threshold for the next sweep of the eye below the average signal intensity of the iris area determined at 254. This means that reflections with intensity that exceed the pupil threshold will be considered as coming from other than the pupil region, and reflections with intensity that do not exceed the pupil threshold will be considered as coming from the pupil region. In a non-limiting example, processor 182 may set the pupil threshold for the next sweep of the eye to be 80% to 95% of the average signal intensity determined at 254. The process described above is repeated for each current sweep, and the pupil threshold obtained in each current sweep is used by the pupil comparator for the next sweep.

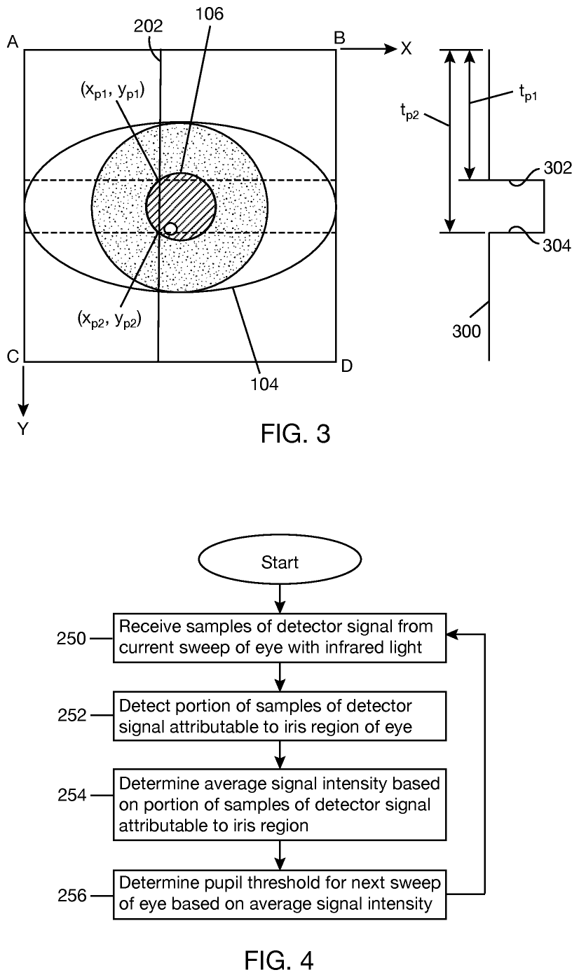

Detecting samples of the detector signal attributable to the iris region of the eye may include determining where the iris may be positioned relative to the scan area. For illustrative purposes, FIG. 5 shows iris 108 of eye 104 relative to scan area ABCD. If the position of the edge of pupil 106 in the scan area ABCD is known, then all that is needed is a small offset from the edge of pupil 106 to be in the iris 108 of eye 104. FIG. 5 shows scan line 214 intersecting the edge of pupil 106 at (xₚ₁, yₚ₁). Line 216 corresponds to time tₚ₁ on signal 300 at tₚ₃ (tₚ₁ represents the time that the laser beam spot is at yₚ₁ relative to beginning of scan line 214; tₚ₃ represents the time that the current scan line began relative to the time that the current sweep of the eye began). Lines 218, 220 correspond to times tᵢ₁ and tᵢ₂, respectively, on signal 300 at tₚ₃. Times tᵢ₁ and tᵢ₂ are obtained by applying small offsets to time tₚ₁ (tᵢ₁ and tᵢ₂, represent the times that the laser beam spot was at yᵢ₁ and yᵢ₂, respectively, relative to the beginning of scan line 214). If the offsets are small enough, both lines 218, 220 will intersect iris 108, as shown in FIG. 5. Detected reflections from the portion of the scan line 214 between tᵢ₁ and tᵢ₂ will be within iris 108. Another scan line, e.g., scan line 222, may be selected that intersects the edge of pupil 106 and iris 108, and detected reflections from the portion of the scan line 222 between tᵢ₁ and tᵢ₂ will also be within iris 108. It should be noted that the offsets, represented by lines 218, 220, do not have to be above the pupil 106 as shown in FIG. 5. The offsets could be below the pupil 106, for example.

In one example, detecting samples of the detector signal attributable to an iris region of the eye may include processor 182 (in FIGS. 1A and 1B) (i) receiving samples of the detector signal from the current sweep of the eye through path 156 (in FIGS. 1A and 1B), (ii) determining tₚ₁ and tₚ₃ for scan lines that intersect pupil 106 from latched values in timer-counter circuitry (170 in FIG. 1A, 170a in FIG. 1B), (iii) selecting a tₚ₁ associated with a scan line, (iv) applying small offsets to the selected tₚ₁ to obtain tᵢ₁ and tᵢ₂, and (v) determining which samples were generated between tᵢ₁ and tᵢ₂ at the tₚ₃ associated with the selected tₚ₁. Processor 182 may repeat from (iii) to (v) for additional scan lines that intersect pupil 106 to obtain a plurality of samples coming from the iris area. The process logic for detecting samples of the detector signal coming from an region iris of the eye may be stored in memory 184 and executed by processor 182, as described above.

Referring to FIGS. 1A and 1C, in one implementation, glint detection circuitry 160 includes a glint comparator 162 (e.g., an operational amplifier) that takes the detector signal from signal conditioning circuitry 120 as a first input and a glint threshold signal as a second input. The glint threshold signal indicates the maximum intensity that must be exceeded by the detector signal to consider the detector signal as coming from a glint on the eye. Glint comparator 162 may receive the detector signal through a path 164 coupling signal conditioning circuitry 120 to a first input node of glint comparator 162. Glint comparator 162 may receive the glint threshold signal through a path 165 coupling processor module 180 to a second input node of glint comparator 162. In one example, path 165 includes a DAC 166 to convert the digital signal from processor module 180 to an analog signal that is received by the glint comparator 162. Glint comparator 162 compares the detector signal to the glint threshold signal and generates a digital signal that is representative of the comparison. As an example, if the voltage of the detector signal is greater than the voltage of the glint threshold signal, the glint comparator 162 generates a digital signal having a first logical value. If the voltage of the detector signal is not greater than the voltage of the glint threshold signal, the glint comparator 162 generate a digital signal having a second logical value that is different from the first logical value. For example, the first logical value could be 1 and the second logical value could be 0. However, other logical values may be used. Timer-counter circuitry 170 (170b) detects rising and falling edges from the output of the glint comparator 162. Edges occur when the value of the digital signal coming out of glint comparator 162 changes. For example, a falling edge may be detected when the output of the glint comparator 162 changes from 1 to 0 (or from the first logical value to the second logical value), and a rising edge may be detected when the output of the glint comparator 162 changes from 0 to 1 (or from the second logical value to the first logical value). Each rising or falling edge corresponds to a point on the glint.

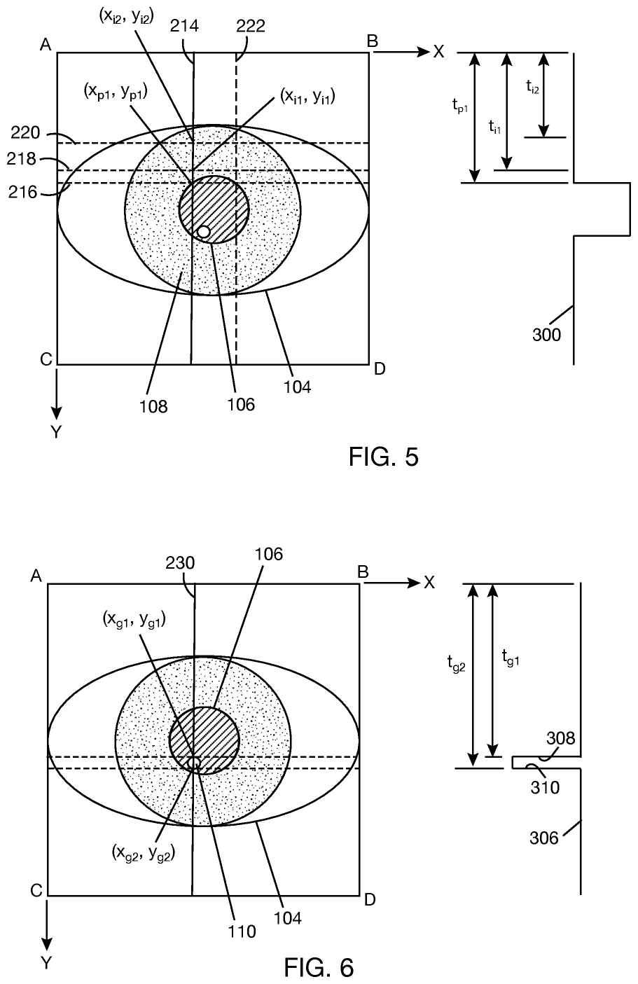

For illustrative purposes, FIG. 6 shows glint 110 on eye 104 and a scan line 230 intersecting glint 110 at (x_{g1}, y_{g1}) and (x_{g2}, y_{g2}). Line 306 represents a signal that may be generated for scan line 230 by glint comparator 162 (in FIGS. 1A and 1C). Line portion 308 represents the rising edge of the signal, and line portion 310 represents the falling edge of the signal. Time t_{g1} represents the time that the laser beam spot is at y_{g1} relative to the beginning of scan line 230 on line AB. Time t_{g2} represents the time that the laser beam spot is at y_{g2} relative to the beginning of the scan line 230 on line AB. A third time t_{g3} can be introduced. Time t_{g3} represents the time that the current scan line 230 began relative to the time that the current sweep of the eye began. From time t_{g1}, the position y_{g1} can be inferred. From time t_{g2}, the position y_{g2} can be inferred. From time t_{g3}, and with knowledge of the slope of scan line 230, the positions x_{g1} and x_{g2} can be inferred.

Returning to FIGS. 1A and 1C, in one implementation, timer-counter circuitry 170 (170b) includes sync register 172 that is coupled to receive a fast-axis timing signal FSYNC from the scan mirror driver (or optical scanner driver), sync register 173 that is coupled to receive a slow-axis timing signal SSYNC from the scan mirror driver (or optical scanner driver), a capture register 178 that is coupled to an output of glint comparator 162, and counter 174. Registers 172, 173, and 178 and counter 174 may be implemented using register-type circuit such as the flip-flop. Registers 172, 173, 178 are coupled to receive counter values from counter 174, as indicated by line 175. Registers 172, 173, 178 and counter 174 are synchronized to clock 188, as indicated by line 176. Each clock cycle, capture register 178 detects the output signal of the glint comparator 162. When the value of the output signal of the glint comparator 162 changes from a first logical value to a second logical value or from a second logical value to a first logical value, which corresponds to detection of a glint edge, capture register 178 latches the value of counter 174 and generates an interrupt signal that is received by processor 182, as indicated by line 179. When register 172 receives fast-axis timing signal FSYNC, sync register 172 latches the value of counter 174. When register 173 receives slow-axis timing signal SSYNC, sync register 173 latches the value of counter 174.

Upon receiving an interrupt signal from register 178, processor 182 retrieves the latched values in registers 178, 172, and 173, as indicated by lines 198, 192, and 193, respectively. Processor 182 computes time t_{g1} (or t_{g2}), as previously explained with respect to FIG. 6, from the difference between the latched value retrieved from the capture register 178 and the latched value retrieved from sync register 172. Processor 182 computes time t_{g3}, as previously explained, from the difference between the latched value retrieved from the capture register 178 and the latched value retrieved from sync register 173. Thus, for each point on a glint edge detected by capture register 178, processor 182 computes time coordinate (t_{g1}, t_{g3}) or (t_{g2}, t_{g3}) for the point. In one example, processor 182 may compute display coordinate (x_{g1}, y_{g1}) corresponding to time coordinate (t_{g1}, t_{g3}) and display coordinate (x_{g2}, x_{g3}) corresponding to time coordinate (t_{g2}, t_{g3}). A relationship may be determined a priori between time coordinates and display coordinates using affine transformation and the like, and the processor 182 may use the relationship to determine display coordinates from time coordinates—this may be the same relationship used in determining display coordinates from time coordinates based on pupil edge detection.

For each sweep of the eye, processor 182 computes a set of time coordinates and/or display coordinates for points on the edge of the glint. In a further example, processor 182 may compute glint center position from the set of display coordinates. The glint center position may be determined as a weighted average of the display coordinates, or a weighted centroid of a shape formed by the display coordinates. Processor 182 may store the glint edge data (time coordinates and/or display coordinates and/or glint center position) in memory 180 and/or output the glint edge data to an external process or device. For example, a gaze point calculator (not shown) may receive the glint center position and use the glint center position in determining a gaze point of the eye in a display space. Alternatively, the gaze point calculator may receive the time and/or display coordinates, determine the glint center position from the time and/or display coordinates, and use the glint center position in determining a gaze point of the eye in a display space.

The processor 182 determines the glint threshold that is provided to the second input of the glint comparator 162. The processor 182 may set the glint threshold to a value that does not change with eye illumination conditions. Alternatively, the processor 182 may adjust the glint threshold with changing eye illumination conditions. For example, the intensity of the detector signal in the glint area is expected to be greater than the intensity of the detector signal in the iris area. Using a procedure similar to what is described above with reference to FIG. 4, a maximum signal intensity in the iris area can be determined, and the glint threshold can be set to be above the maximum signal intensity. Another consideration with respect to glint is that there can be multiple glints on an eye for each sweep of the eye. Typically, these glints will produce reflections with different intensities. Therefore, the glint threshold may be set high enough such that only one glint is detected for each sweep of the eye. Alternatively, multiple glints may be detected for each sweep of the eye, and the processor 182 may use clustering to determine which time and/or display coordinates belong together to define a glint. Alternatively, any post processing to separate out the glints may be done outside of the processor module 180, e.g., in the gaze position calculator.

From the foregoing discussion, processor 182 can retrieve latched counter values from timer-counter circuitry 170 (170a) and determine time and/or display coordinates of points on an edge of a pupil. Processor 182 can retrieve latched counter values from timer-counter circuitry 170 (170b) and determine time and/or display coordinates of points on an edge of one or more glints. Processor 182 may output the time and/or display coordinates of points on the pupil edge and points on the glint edge to another device or process. Alternatively, processor module 180 may compute pupil center position and glint center position from the corresponding time and/or display coordinates and output the pupil center position and glint center position to the other device or process. In one example, a gaze point calculator receives the time and/or display coordinates, or pupil center position and glint center position, from processor 182 and uses the time and/or display coordinates, or pupil center position and glint center position, to compute a gaze point of the eye in a display space. Examples of methods of computing gaze point in a display space by glint position and/or glint-pupil vector are disclosed in U.S. Provisional Application Nos. 62/658436, 62/658434, and 62/658431, the disclosures of which are incorporated herein by reference.

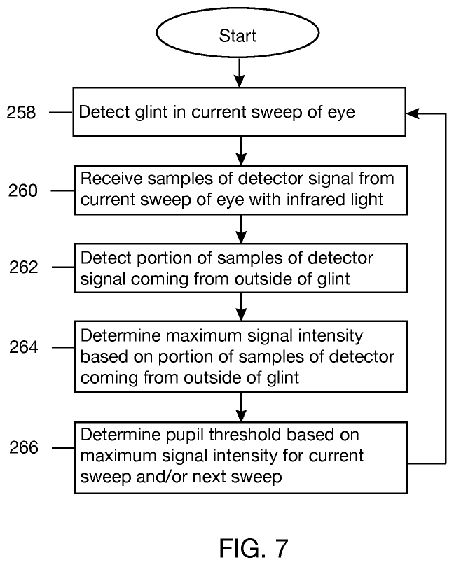

FIG. 7 illustrates a process for determining and dynamically adjusting the pupil threshold provided to the pupil comparator 142 (in FIG. 1A) according to another implementation. At 258, processor 182 detects a glint during a current sweep of the eye with infrared light. Processor 182 detects the glint when capture register 178 (in FIG. 1A) generates an interrupt signal that is received by processor 182. At 260, processor 182 receives samples of the detector signal from the current sweep of the eye with infrared light. As shown in FIG. 1A, the detector signal may be sampled through path 156 formed between pupil edge comparator circuitry 140 and processor module 180. At 262, processor 182 detects the portion of the samples that is attributable to a region outside of the glint, i.e., the samples generated by reflections from the eye that are outside of the glint. This portion of the samples would be samples received after detecting a falling edge from the output of glint comparator 162 (in FIG. 1A). At 264, processor 182 determines a maximum signal intensity from the samples attributable to a region of the eye outside of the glint. At 266, processor 182 sets the pupil threshold for the remainder of the current sweep to the maximum signal intensity. The pupil threshold at 266 may also be used for at least a portion of the next sweep of the eye.

The process described in FIG. 7 may be used alone or in combination with the process described in FIG. 4. For example, the process described in FIG. 7 may be used to determine pupil threshold for a first sweep of the eye, and the process described in FIG. 4 may be used to determine pupil threshold for subsequent sweeps of the eye. Alternatively, both processes may be used to compute pupil threshold during each sweep of the eye, and a combination of the pupil thresholds, such as an average of the pupil thresholds, computed by both processes may be provided to the pupil comparator.

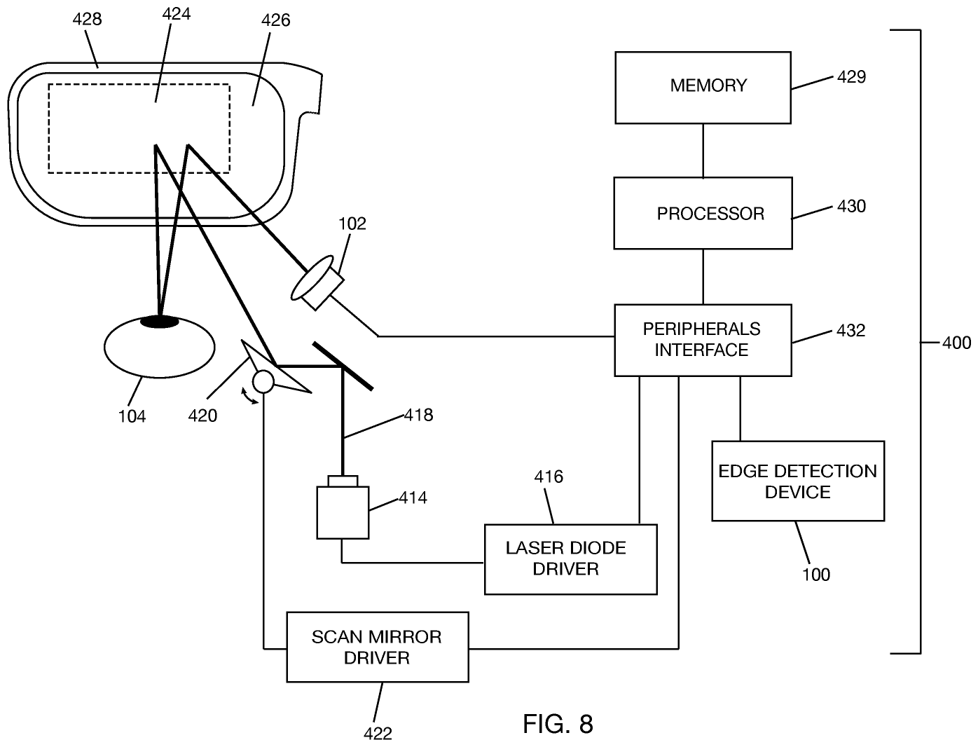

FIG. 8 is a schematic diagram illustrating a wearable heads-up display system 400 including edge detection circuit 100 of FIG. 1A (or 100a of FIG. 1B, 100b of FIG. 1C) In one implementation, system 400 includes a laser diode module 414 that is operable to generate a laser beam 418. Laser diode module 414 includes at least one infrared laser diode to generate infrared light and at least one visible laser diode to generate visible light. In general, laser diode module 414 may have any number and combination of laser diodes to generate infrared light and visible light. In one example, laser diode module 414 includes an infrared laser diode (not shown separately) to generate infrared light and a plurality of visible laser diodes (not shown separately) to generate visible light in different narrow visible wavebands. As a further example, the visible laser diodes may include at least one red laser diode to generate red light, at least one green laser diode to generate green light, and at least one blue laser diode to generate blue light. As used herein and in the claims, the adjectives used before the term “laser diode” or “laser diodes” refer to a characteristic of the output of the laser diode or laser diodes, e.g., the wavelength(s) or band of wavelengths of light output by the laser diode or laser diodes. Laser diode module 414 may include optics (not shown separately) to combine the output beams of multiple laser diodes into a single combined beam that is outputted as laser beam 418. System 400 may include a laser diode driver 416 to switch the laser diode(s) in the laser diode module 414 on at the required optical power or to switch the laser diode(s) off.

System 400 includes an optical scanner 420 that is positioned, oriented, and operable to receive laser beam 418 from laser diode module 414 and scan or sweep the laser beam 418 across eye 104. In one example, optical scanner 420 includes a two-dimensional scan mirror operable to scan in two directions, for example, by oscillating or rotating with respect to two axes. In another example, optical scanner 420 includes two orthogonally-oriented mono-axis mirrors, each of which oscillates or rotates about its respective axis. The mirror(s) of optical scanner 420 may be micromechanical systems (MEMS) mirrors, piezoelectric mirrors, and the like. In operation, optical scanner 420 may scan the laser beam 418 over eye 104 by sweeping through a range of scan orientations. For each scan orientation, optical scanner 420 may receive laser beam 418 from laser diode module 414 and reflect the laser beam into a respective region of eye 104. System 400 may include a scan mirror driver 422 to provide the voltage to drive the mirrors of optical scanner 420 about their respective axis. Scan mirror driver 422 may also generate timing signals that may be communicated to laser diode driver 416 to synchronize laser beam output with motion of the scan mirrors. These timing signals may also be received in the edge detection circuit 100 as previously explained. In another implementation, optical scanner 420 may be a mirrorless optical scanner, such as fiber optic scanner, or may include a combination of mirror and mirrorless optical scanning elements.

In one implementation, optical scanner 420 is positioned and oriented to reflect laser beam 418 from laser diode module 414 to a transparent combiner 424, which in the example shown in FIG. 8 is integrated with a transparent lens 426. In one example, lens 426 is mounted in a support frame 428 having a form factor of eyeglasses (only the portion of the support frame 428 carrying transparent lens 426 is shown in FIG. 8). When the support frame 428 is worn on a head of a user having at least eye 104, transparent combiner 424 is positioned in a field of view of eye 104, which allows transparent combiner 424 to redirect the light that it receives from optical scanner 420 to eye 104. Transparent combiner 424 may be a holographic optical element having at least one hologram that is responsive to infrared light and unresponsive to visible light, a waveguide or light guide with an in-coupler to receive infrared light from optical scanner 420 and an out-coupler to output infrared light that is directed to eye 104, or other light redirecting element that may be integrated into lens 426 while maintaining transparency of lens 426. Where transparent combiner 424 is a holographic optical element having at least one hologram that is responsive to infrared light and unresponsive to visible light, the holographic optical element may further include at least one hologram that is responsive to visible light and unresponsive to infrared light.

System 400 includes infrared detector 102 to detect reflections of infrared light from eye 104. In general, an infrared detector is a device that is sensitive to and responsive to infrared light and that provides signals responsive to sensing or detecting infrared light. In one example, infrared detector 102 includes at least one photodiode sensor or photodetector that is responsive to infrared light. Infrared detector 102 may detect reflections of infrared light directly from eye 104 and/or from transparent combiner 424 (detecting reflections of infrared light is possible since transparent combiner 424 is in the field of view of eye 104 and receives reflections of infrared light from eye 104). Reflections of infrared light detected by infrared detector 102 may be processed to obtain information about where eye 104 is gazing at the time the reflections were detected. For example, information about the position of a glint on eye 104 and the position of the pupil of eye 104 can be extracted from the detected reflections of infrared light and used to determine the gaze point of eye 104 relative to the display space. In one implementation, infrared detector 102 is communicatively coupled to edge detection circuit 100, which allows edge detection circuit 100 to detect glint and/or pupil from the output signal of the infrared detector 102.

System 400 may include one or more non-transitory storage media or memory 429 to store processor-executable instructions and data. Memory 429 may be random-access memory, read-only memory, flash memory, solid state drive, or other processor-readable memory storage device. In one example, memory 429 contains gaze point calculation logic that uses glint data and/or pupil data from edge detection circuit 100 (100a, 100b) to compute a gaze point of eye 104 relative to the display space. System 400 may include one or more processors 430 to execute instructions on memory 429. Processor(s) 28 can take the form of, for example, microcontroller(s), microprocessor(s), central processing unit(s) (CPU(s)), application specific integrated circuit (ASIC(s)), field-programmable gate array(s) (FPGA(s)), and the like. System 400 may include peripherals interface 432 to enable movement of data between the various components of the system.

The foregoing detailed description has set forth various implementations or embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In at least one implementation or embodiment, the present subject matter may be implemented via Application Specific Integrated Circuits (ASICs). However, those skilled in the art will recognize that the implementations and the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this disclosure, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples of the processor-readable medium are a portable computer diskette (magnetic, compact flash card, secure digital, or the like), a random-access memory (RAM), a read-only memory (ROM), an erasable programmable read-only memory (EPROM, EEPROM, or Flash memory), a portable compact disc read-only memory (CDROM), digital tape, and other non-transitory medium.

The above description of illustrated embodiments, including what is described in the Abstract of the disclosure, is not intended to be exhaustive or to limit the embodiments to the precise forms disclosed. Although specific embodiments and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

1. An edge detection circuit that in use is communicatively coupled to an infrared detector that is positioned and oriented to detect reflections of infrared light from an eye, the edge detection circuit comprising:
an edge comparator circuitry comprising a comparator having a first input node to receive an infrared detector output signal from the infrared detector, a second input node to receive a feature threshold signal of a select feature of the eye, and an output node to output a comparator output signal representative of a comparison between the infrared detector output signal and the feature threshold signal, the select feature of the eye comprising at least one of a pupil of the eye and a glint on the eye;
a timer-counter circuitry communicatively coupled to the edge comparator circuitry, the timer-counter circuitry comprising:
a counter that is responsive to a source of successive clock signals; and
a capture register communicatively coupled to the output node of the comparator to detect rising and falling edges of the comparator output signal and to an output node of the counter to latch a value of the counter when a rising edge or a falling edge of the comparator output signal is detected; and
a processor module communicatively coupled to the edge comparator circuitry and the timer-counter circuitry, the processor module comprising:
a processor communicatively coupled to the second input node of the comparator to provide the feature threshold signal to the second input node of the comparator, the processor communicatively coupled to the capture register to receive an interrupt signal from the capture register and to retrieve the counter value latched in the capture register in response to the interrupt signal received from the capture register.

2. The edge detection circuit of claim 1, wherein the select feature of the eye is a pupil of the eye.

3. The edge detection circuit of claim 2, wherein the edge comparator circuitry further comprises a path through which the infrared detector output signal is received at the first node of the comparator, wherein the path includes an amplifier to boost a power of the infrared detector output signal.

4. The edge detection circuit of claim 3, wherein the path through which the infrared detector output signal is received at the first node of the comparator further includes a clamping circuit to clamp the infrared detector output signal received at an input of the amplifier to a defined voltage range.

5. The edge detection circuit of claim 2, wherein the edge comparator circuitry further comprises a path through which the infrared detector output signal is provided to the processor module, wherein the path includes an analog-to-digital converter.

6. The edge detection circuit of claim 1, wherein the edge comparator circuitry further comprises a path through which the feature threshold signal is received at the second node of the comparator, wherein the path includes a digital-to-analog converter.

7. The edge detection circuit of claim 1 wherein the timer-counter circuitry further comprises a first sync register communicatively coupled to receive a first timing sync signal, the first sync register communicatively coupled to the counter and operable to latch the value of the counter in response to receiving the first timing sync signal.

8. The edge detection circuit of claim 7, wherein the timer-counter circuitry further comprises a second sync register communicatively coupled to receive a second timing sync signal, the second sync register communicatively coupled to the counter and operable to latch the value of the counter in response to receiving the second timing sync signal.

9. The edge detection circuit of claim 8, wherein the processor is communicatively coupled to each of the first sync register and the second sync register to receive the counter value latched in each of the first sync register and the second sync register in response to the interrupt signal from the capture register.

10. The edge detection circuit of claim 8, wherein the processor module further comprises a clock, and wherein the capture register, the counter, the first sync register, and the second sync register are communicatively coupled to the clock to receive clock signals.

11. The edge detection circuit of claim 8, wherein the processor module further comprises a non-transitory processor-readable storage medium that is communicatively coupled to the processor, wherein the non-transitory processor-readable storage medium stores data and/or processor-executable instructions that, when executed by the processor, cause the processor to determine a coordinate of a point on an edge of the select feature of the eye based on the counter values retrieved from the capture register, the first sync register, and the second sync register.

12. The edge detection circuit of claim 1, further comprising a signal conditioning circuitry communicatively coupled to the edge comparator circuitry, the signal conditioning circuitry comprising a transimpedance amplifier that converts the infrared detector output signal from a current signal to a voltage signal.

13. The edge detection circuit of claim 12, wherein the signal conditioning circuitry further comprises a filter to reject ambient light from the infrared detector output signal.

14. The edge detection circuit of claim 12, wherein the signal conditioning circuitry further comprises a bandpass filter to pass a select frequency range of the infrared detector output signal.

15. The edge detection circuit of claim 2, wherein the processor is communicatively coupled to the edge comparator circuitry to receive samples of the infrared detector output signal from the edge comparator circuitry, and wherein the processor module further comprises a non-transitory processor-readable storage medium that is communicatively coupled to the processor, wherein the non-transitory processor-readable storage medium stores data and/or processor-executable instructions that, when executed by the processor, cause the processor to:
detect a portion of the samples of the infrared detector output signal attributable to an iris region of the eye;
determine an average signal intensity of the portion of the samples of the infrared detector output signal attributable to an iris region of the eye; and
determine the feature threshold signal based on the average signal intensity.

16. The edge detection circuit of claim 2, wherein the processor is communicatively coupled to the edge comparator circuitry to receive samples of the infrared detector output signal from the edge comparator circuitry, and wherein the processor module further comprises a non-transitory processor-readable storage medium that is communicatively coupled to the processor, wherein the non-transitory processor-readable storage medium stores data and/or processor-executable instructions that, when executed by the processor, cause the processor to:
detect a portion of the samples of the infrared detector output signal attributable to a region of the eye outside of a glint on the eye;
determine a maximum signal intensity of the portion of the samples of the infrared detector output signal attributable to the region of the eye outside of the glint on the eye; and
determine the feature threshold signal based on the maximum signal intensity.

17. The edge detection circuit of claim 1, wherein the timer-counter circuitry and processor module are implemented in a microcontroller.

18. A method of detecting one or more features of an eye, the method comprising:
generating an infrared light;
sweeping the infrared light across the eye;
detecting, by an infrared detector, reflections of the infrared light from the eye;
receiving at a first input node of a comparator an infrared detector output signal from the infrared detector;
receiving a feature threshold signal of a select feature of the eye from a processor at a second input node of the comparator;
comparing the infrared detector output signal to the feature threshold signal in the comparator and outputting a comparator output signal from the comparator that is representative of the comparison between the infrared detector output signal and the feature threshold signal;
detecting, by a register, rising and falling edges of the comparator output signal;
capturing in the register a time of arrival of at least one of the rising and falling edges of the comparator output signal; and
determining a coordinate of at least one point on an edge of the select feature based on the time of arrival captured in the register.

19. The method of claim 18, wherein the select feature is selected from a pupil of the eye and a glint on the eye.

20. The method of claim 18, wherein the select feature is a pupil of the eye, and further comprising adjusting the feature threshold signal based on changes in the infrared detector output signal.

21. The method of claim 20, wherein adjusting the feature threshold signal comprises receiving samples of the infrared detector output signal for a current sweep of the eye with infrared light, detecting a portion of the samples attributable to an iris region of the eye, determining an average signal intensity from the portion of the samples attributable to the iris region of the eye, and determining the feature threshold signal for a next sweep of the eye based on the average signal intensity.

22. The method of claim 20, wherein adjusting the feature threshold signal comprises detecting a glint on the eye during a current sweep of the eye with infrared light, receiving samples of the infrared detector output signal from the current sweep of the eye with infrared light, detecting a portion of the samples attributable to a region of the eye outside of the glint on the eye, determining a maximum signal intensity from the portion of the samples attributable to the region of the eye outside of the glint on the eye, and determining the feature threshold signal for at least one of the current sweep of the eye and the next sweep of the eye based on the maximum signal intensity.

23. A system to detect one or more features of an eye, comprising:
a laser module to generate infrared light, the laser module having at least one infrared laser diode;
an optical scanner to sweep the infrared light over the eye, the optical scanner having at least one scan mirror;
an infrared detector positioned and oriented to detect reflections of the infrared light from the eye during each sweep of the infrared light over the eye;
a comparator having a first input node to receive an infrared detector output signal from the infrared detector, a second input node to receive a feature threshold signal of a select feature of the eye, and an output node to output a comparator output signal representative of a comparison between the infrared detector output signal and the feature threshold signal, the select feature of the eye comprising at least one of a pupil and a glint on the eye;
a counter that is responsive to a source of successive clock signals;
a capture register that is communicatively coupled to the output node of the comparator to detect rising and falling edges of the comparator output signal and to an output node of the counter to latch a value of the counter when a rising edge or a falling edge of the comparator is detected;
a processor communicatively coupled to the second input node of the comparator to provide the feature threshold signal to the second input node of the comparator, the processor communicatively coupled to the capture register to receive an interrupt signal from the capture register and to retrieve the counter value latched in the capture register in response to the interrupt signal received from the capture register; and
a non-transitory processor-readable storage medium that is communicatively coupled to the processor, wherein the memory stores data and/or processor-executable instructions that, when executed by the processor, causes the processor to determine a coordinate of a point on an edge of the select feature of the eye based on the counter value received from the register.
